(19) United States
(12) Patent Application Publication
(10) Pub. No.: US 2017/0154482 A1
(43) Pub. Date: Jun. 1, 2017

(54) VEHICLE LIFTGATE AND GARAGE DOOR SYNCHRONIZATION

(71) Applicant: Ford Global Technologies, LLC, Dearborn, MI (US)

(72) Inventor: Kurt David Osborne, Dearborn, MI (US)

(21) Appl. No.: 14/953,062

(22) Filed: Nov. 27, 2015

(51) Int. Cl. G07C 9/00

(52) U.S. Cl. CPC G07C 9/00309; G07C 2009/00928; G07C 2009/00769

(57) ABSTRACT

A vehicle system includes a controller configured to, in response to receiving a request to open a rear enclosure of a vehicle and data indicating that there is an object behind the vehicle, transmit one or more signals to open a door of a garage and inhibit opening the enclosure. The controller is also configured to, in response to the data indicating an absence of objects behind the vehicle, open the enclosure.

### TECHNICAL FIELD

This application is generally related to communication of a vehicle liftgate position between a vehicle and a garage door opener.

### BACKGROUND

Many vehicles are equipped with remote garage door opening systems. These systems enable a vehicle operator to press a button to open or close a garage door. The system uses a transceiver in the vehicle configured to communicate with a garage door opener. The transceiver is configured to receive a signal indicative of an RF sequence required to activate a garage door opener. The RF sequence is received from a garage door opener remote control unit. Upon reception of the signal, the controller stores the RF sequence. When the button is pressed, the controller transmits the RF sequence to active the garage door opener.

### SUMMARY

A vehicle system includes a controller configured to, in response to receiving a request to open a rear enclosure of a vehicle and data indicating that there is an object behind the vehicle, transmit one or more signals to open a door of a garage and inhibit opening the enclosure. The controller is also configured to, in response to the data indicating an absence of objects behind the vehicle, open the enclosure.

The controller may be further configured to, in response to the data indicating a presence of objects behind the vehicle and location data for the vehicle indicating that the vehicle is in the garage, inhibit opening the enclosure.

A vehicle may include a rear access panel and a controller. The controller may be configured to, in response to receiving a request to close a door of a garage and a signal indicating that the rear access panel is open, close the rear access panel prior to transmitting a signal to close the door.

A method for activating a vehicle system may include, in response to receiving a request to remote start the vehicle and data indicating that the vehicle is in a garage and that there is an object behind the vehicle, transmitting by a controller a signal to open a door of the garage, and in response to the data indicating that the object is no longer behind the vehicle, honoring by the controller the request.

### BRIEF DESCRIPTION OF THE DRAWINGS

FIGS. 1A and 1B are an exemplary block topology of a vehicle infotainment system.

FIG. 2 is an exemplary cut away illustration of a communication system between a house having a garage and a vehicle with an open liftgate in the garage.

FIG. 3A is a rear view of a vehicle having a liftgate in a closed position and rear sensors of the vehicle.

FIG. 3B is a rear view of a vehicle having a liftgate in an open position illustrating a range of motion of the liftgate.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programmed to perform any number of the functions as disclosed.

This disclosure, among other things, proposes communication systems and methods for a vehicle to communicate with a garage door mechanism and more specifically with a garage door controller also referred to as a garage door opener. The communication may be wireless or may be a wire connection. A wireless connection may include a direct connection between a wireless transceiver in the vehicle and a controller for the garage door opener. This connection would be directly with the controller of the garage door opener. Typically, this would utilize a signal transmitted and received wirelessly on a band of radio frequency (RF) energy at or around 390 MHz or 315 MHz but may also be at other frequencies such as 310 MHz, 318 MHz, or 372.5 MHz. Along with a dedicated frequency band upon which to communicate, the communication may between the vehicle and garage door opener may be encrypted requiring a key. The key may be a single value, also referred to as a static value, such as one based positions of switches like DIP switches connected to the controller, or a value held in a variable or memory location. The key may also change with time, also referred to as a dynamic code, such as that of a rolling code. In another embodiment, the connection may be from an embedded modem of the vehicle to the controller of the garage door opener. The embedded modem may be a standalone module in the vehicle or may be integrated into another module such as an infotainment system. The vehicle may communicate directly with the controller of the garage door opener, or may communicate with the controller of the garage door opener via a home computer or home network.

The vehicle may also have sensors located to the rear of the vehicle. The sensors may be used in a backup alert system, collision avoidance system, blind spot detection system, rear camera system, or a cross traffic detection system. The sensors may use many different technologies or be a combination of the many technologies including as ultrasound, infrared, visible light, LiDAR, or RADAR. The sensors may be able to detect objects to the rear of the vehicle such as a shut garage door. The sensors may detect the presence or absence of objects to the rear of the vehicle. Combined with GPS data, the sensors may be able to detect of a garage door is open (i.e., a signal indicative of an absence of objects to the rear of the vehicle) or closed (i.e., a signal indicative of a presence of objects to the rear of the vehicle). If the vehicle receives a trunk-open request signal to open a rear enclosure, the vehicle may activate the sensors to check and determine if the rear of the vehicle is clear of obstructions. If the sensors detect that there is an object such as a garage door, the vehicle may transmit a garage-open signal or a garage-stop signal to the controller of a garage door opener to open or stop the garage door. The sensors may continue to monitor the sensors to verify that the garage door is opened by the garage-open signal, and after verification, the vehicle may signal to a controller including a power lift gate module, power hatch module, or door module to open the rear enclosure. This control strategy may be implemented by a vehicle or may be integrated into a smart garage door opener. Another example is a garage door close request that may be originated at a switch mounted on a wall of the house, an application running on a computing platform such as a smart phone, tablet, computer, smart wearable device, or other personal computing device networked with the garage door, or a request from a vehicle from an interior switch, an infotainment system, or an application running on a computing platform such as a smart phone, tablet, computer, smart wearable device, or other personal computing device networked with the vehicle. Here, upon receipt of the garage door close request, the vehicle activates vehicle sensors. The vehicle sensors may be able to detect the position of a rear enclosure such as a rear lift gate, tail gate, hatch, or door. The vehicle sensors may include a switch, pressure membrane, or other sensor coupled with the rear enclosure configured to check and determine if the rear enclosure is in a closed and latched position. If the sensors detect that the rear enclosure is shut, the vehicle may transmit a garage-close signal to the controller of a garage door opener to close the garage door.

In an alternative embodiment, the vehicle may be a plug-in hybrid vehicle (PHEV) or a battery electric vehicle (BEV). When the PHEV or BEV is plugged into a home charging station, the vehicle may be able to communicate via the plug to a home network. The vehicle may be able to utilize the home network to communicate with the garage door opener and control the operation of the garage door based on the position of the rear enclosure of the vehicle. Further, the vehicle may also utilize global positioning system (GPS) data to limit the operation of the rear enclosure or to communicate with a garage door opener to avoid contact of the garage door and rear enclosure. Likewise, the PHEV or BEV may be inductively coupled with the charge station and the communication between the vehicle and the house may be via the inductive coupling used for charging.

The communication between the vehicle and controller of the garage door opener is not limited to motion of the rear enclosure. The vehicle may communicate with the controller of the garage door opener to open the garage door upon receiving a request to remote-start, also referred to as to auto-start the vehicle. Remote-start is when a controller in the vehicle activates an internal combustion engine (ICE) to start operation of the ICE. Typically, remote-start is a function performed in response to depression of a button on a key-fob that is produces a signal. The signal is then encoded and transmitted wirelessly over an RF band to the vehicle. Upon reception of the signal, the controller activates the powertrain control module (PCM) and starts operation of the vehicle. The remote-start of the ICE may be performed while the vehicle is in a key-off state, which is when an ignition key is not inserted into a key receptacle, to warm the ICE, to operate a heater to warm an interior of the vehicle, or to operate an air-conditioning unit to cool the interior. The key-fob may operate at a wireless carrier frequency, of 315 MHz, 433 MHz, or other frequency. The signal from the key-fob may utilize frequency-shift keying (FSK) modulation or amplitude-shift keying (ASK). The transceiver module in the vehicle that that communicates with the key-fob may also be configured to communicate with controllers of various garage door openers. The transceiver module may be a standalone module or may be integrated into an infotainment system or other communication module.

The communication between the vehicle and a vehicle infrastructure such as a garage door opener, or a controller may be a direct RF link between the vehicle infrastructure (e.g., garage door opener) and an RF transceiver in the vehicle. The RF transceiver may be a standalone module configured to transmit receive energy in a band used for the infrastructure (e.g., a homelink RF module) or may be integrated into an RF module of the vehicle (e.g., a tire pressure monitoring system TPMS module, or a remote keyless entry RKE module). Alternatively, the communication may be indirect such as a message from a garage door opener routed through a home network to a telematic service of an infotainment system, to a vehicle controller. Likewise, the communication may be from a mobile device through a wireless network, to a vehicle infotainment system and to a garage door opener controller.

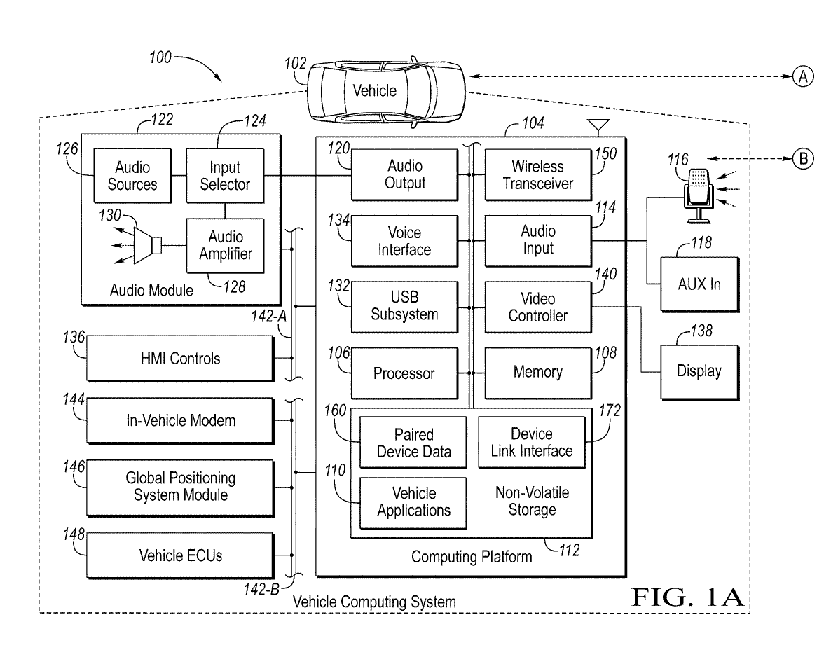

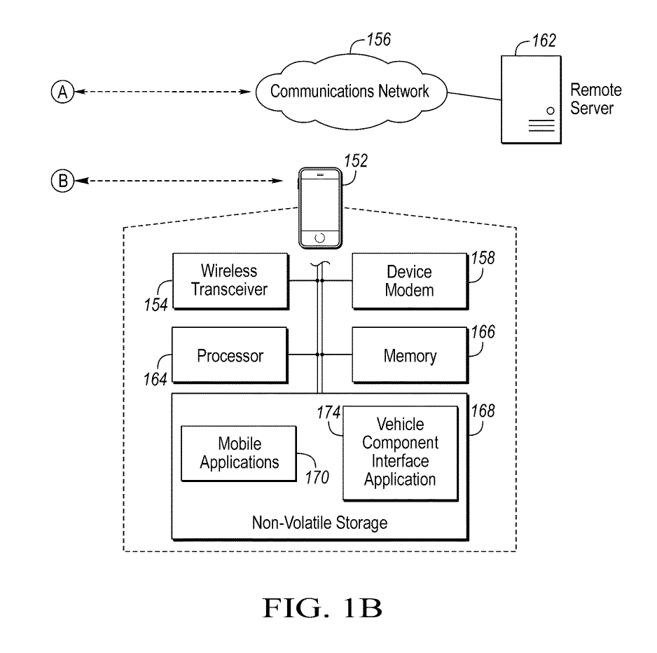

FIGS. 1A and 1B illustrate an example diagram of a system 100 that may be used to provide telematics services to a vehicle 102. The vehicle 102 may be one of various types of passenger vehicles, such as a crossover utility vehicle (CUV), a sport utility vehicle (SUV), a truck, a recreational vehicle (RV), a boat, a plane or other mobile machine for transporting people or goods. Telematics services may include, as some non-limiting possibilities, navigation, turn-by-turn directions, vehicle health reports, local business search, accident reporting, and hands-free calling. In an example, the system 100 may include the SYNC system manufactured by The Ford Motor Company of Dearborn, Mich. It should be noted that the illustrated system 100 is merely an example, and more, fewer, and/or differently located elements may be used.

The computing platform 104 may include one or more processors 106 configured to perform instructions, commands and other routines in support of the processes described herein. For instance, the computing platform 104 may be configured to execute instructions of vehicle applications 110 to provide features such as navigation, accident reporting, satellite radio decoding, and hands-free calling. Such instructions and other data may be maintained in a non-volatile manner using a variety of types of computer-readable storage medium 112. The computer-readable medium 112 (also referred to as a processor-readable medium or storage) includes any non-transitory medium (e.g., a tangible medium) that participates in providing instructions or other data that may be read by the processor 106 of the computing platform 104. The processor may also be multiple processors in multiple computing units, which each perform a part of the overall driver alert. For example, one processor may perform audible alert functions, located in the audio module (122), while a different processor in the video controller (140) handles the visual alert, predicated from the same alert message. Computer-executable instructions may be compiled or interpreted from computer programs created using a variety of programming languages and/or technologies, including, without limitation and either alone or in combination, Java, C, C++, C#, Objective C, Fortran, Pascal, Java Script, Python, Perl, and PL/SQL.

The computing platform 104 may be provided with various features allowing the vehicle occupants to interface with the computing platform 104. For example, the computing platform 104 may include an audio input 114 configured to receive spoken commands from vehicle occupants through a connected microphone 116, and auxiliary audio input 118 configured to receive audio signals from connected devices. The auxiliary audio input 118 may be a physical connection, such as an electrical wire or a fiber optic cable, or a wireless input, such as a BLUETOOTH audio connection. In some examples, the audio input 114 may be configured to provide audio processing capabilities, such as pre-amplification of low-level signals, and conversion of analog inputs into digital data for processing by the processor 106.

The computing platform 104 may also provide one or more audio outputs 120 to an input of an audio module 122 having audio playback functionality. In other examples, the computing platform 104 may provide the audio output to an occupant through use of one or more dedicated speakers (not illustrated). The audio module 122 may include an input selector 124 configured to provide audio content from a selected audio source 126 to an audio amplifier 128 for playback through vehicle speakers 130 or headphones (not illustrated). The audio sources 126 may include, as some examples, decoded amplitude modulated (AM) or frequency modulated (FM) radio signals, and audio signals from compact disc (CD) or digital versatile disk (DVD) audio playback. The audio sources 126 may also include audio received from the computing platform 104, such as audio content generated by the computing platform 104, audio content decoded from flash memory drives connected to a universal serial bus (USB) subsystem 132 of the computing platform 104, and audio content passed through the computing platform 104 from the auxiliary audio input 118.

The computing platform 104 may utilize a voice interface 134 to provide a hands-free interface to the computing platform 104. The voice interface 134 may support speech recognition from audio received via the microphone 116 according to grammar associated with available commands, and voice prompt generation for output via the audio module 122. In some cases, the system may be configured to temporarily mute or otherwise override the audio source specified by the input selector 124 when an audio prompt is ready for presentation by the computing platform 104 and another audio source 126 is selected for playback.

The computing platform 104 may also receive input from human-machine interface (HMI) controls 136 configured to provide for occupant interaction with the vehicle 102. For instance, the computing platform 104 may interface with one or more buttons or other HMI controls configured to invoke functions on the computing platform 104 (e.g., steering wheel audio buttons, a push-to-talk button, instrument panel controls, etc.). The computing platform 104 may also drive or otherwise communicate with one or more displays 138 configured to provide visual output to vehicle occupants by way of a video controller 140. In some cases, the display 138 may be a touch screen further configured to receive user touch input via the video controller 140, while in other cases the display 138 may be a display only, without touch input capabilities.

The computing platform 104 may be further configured to communicate with other components of the vehicle 102 via one or more in-vehicle networks 142. The in-vehicle networks 142 may include one or more of a vehicle controller area network (CAN), an Ethernet network, and a media oriented system transfer (MOST), as some examples. The in-vehicle networks 142 may allow the computing platform 104 to communicate with other vehicle 102 systems, such as a vehicle modem 144 (which may not be present in some configurations), a global positioning system (GPS) module 146 configured to provide current vehicle 102 location and heading information, and various vehicle ECUs 148 configured to cooperate with the computing platform 104. As some non-limiting possibilities, the vehicle ECUs 148 may include a power lift gate control module configured to activate a mechanism to open and close a rear lift gate, a power rear hatch module configured to activate a mechanism to open and close a rear hatch, a powertrain control module configured to provide control of engine operating components (e.g., idle control components, fuel delivery components, emissions control components, etc.) and monitoring of engine operating components (e.g., status of engine diagnostic codes); a body control module configured to manage various power control functions such as exterior lighting, interior lighting, keyless entry, remote start, and point of access status verification (e.g., closure status of the hood, doors and/or trunk of the vehicle 102); and a radio transceiver module configured to communicate with key fobs or other local vehicle 102 devices.

As shown, the audio module 122 and the HMI controls 136 may communicate with the computing platform 104 over a first in-vehicle network 142A, and the vehicle modem 144, GPS module 146, and vehicle ECUs 148 may communicate with the computing platform 104 over a second in-vehicle network 142B. In other examples, the computing platform 104 may be connected to more or fewer in-vehicle networks 142. Additionally or alternately, one or more HMI controls 136 or other components may be connected to the computing platform 104 via different in-vehicle networks 142 than shown, or directly without connection to an in-vehicle network 142.

The computing platform 104 may also be configured to communicate with mobile devices 152 of the vehicle occupants. The mobile devices 152 may be any of various types of portable computing device, such as cellular phones, tablet computers, smart watches, laptop computers, portable music players, or other devices capable of communication with the computing platform 104. In many examples, the computing platform 104 may include a wireless transceiver 150 (e.g., a BLUETOOTH module, a ZIGBEE transceiver, a Wi-Fi transceiver, an IrDA transceiver, an RFID transceiver, etc.) configured to communicate with a compatible wireless transceiver 154 of the mobile device 152. The wireless modules may transmit data at a carrier frequency or a center frequency. The center frequency is an important aspect of a wireless system by impacting noise immunity and bandwidth. For example, typical remote keyless entry systems operate at 315 MHz in the United States, and 433 MHz in Europe, while WiFi and Bluetooth may operate at frequencies including frequencies over 2 GHz such as 2.4 GHz. Additionally or alternately, the computing platform 104 may communicate with the mobile device 152 over a wired connection, such as via a USB connection between the mobile device 152 and the USB subsystem 132.

The communications network 156 may provide communications services, such as packet-switched network services (e.g., Internet access, VoIP communication services), to devices connected to the communications network 156. An example of a communications network 156 may include a cellular telephone network. Mobile devices 152 may provide network connectivity to the communications network 156 via a device modem 158 of the mobile device 152. To facilitate the communications over the communications network 156, mobile devices 152 may be associated with unique device identifiers (e.g., mobile device numbers (MDNs), Internet protocol (IP) addresses, etc.) to identify the communications of the mobile devices 152 over the communications network 156. In some cases, occupants of the vehicle 102 or devices having permission to connect to the computing platform 104 may be identified by the computing platform 104 according to paired device data 160 maintained in the storage medium 112. The paired device data 160 may indicate, for example, the unique device identifiers of mobile devices 152 previously paired with the computing platform 104 of the vehicle 102, such that the computing platform 104 may automatically reconnect to the mobile devices 152 referenced in the paired device data 160 without user intervention.

When a mobile device 152 that supports network connectivity is paired with the computing platform 104, the mobile device 152 may allow the computing platform 104 to use the network connectivity of the device modem 158 to communicate over the communications network 156 with the remote telematics services 162. In one example, the computing platform 104 may utilize a data-over-voice plan or data plan of the mobile device 152 to communicate information between the computing platform 104 and the communications network 156. Additionally or alternately, the computing platform 104 may utilize the vehicle modem 144 to communicate information between the computing platform 104 and the communications network 156, without use of the communications facilities of the mobile device 152.

Similar to the computing platform 104, the mobile device 152 may include one or more processors 164 configured to execute instructions of mobile applications 170 loaded to a memory 166 of the mobile device 152 from storage medium 168 of the mobile device 152. In some examples, the mobile applications 170 may be configured to communicate with the computing platform 104 via the wireless transceiver 154 and with the remote telematics services 162 or other network services via the device modem 158. The computing platform 104 may also include a device link interface 172 to facilitate the integration of functionality of the mobile applications 170 into the grammar of commands available via the voice interface 134 as well as into display 138 of the computing platform 104. The device link interfaced 172 may also provide the mobile applications 170 with access to vehicle information available to the computing platform 104 via the in-vehicle networks 142. Some examples of device link interfaces 172 include the SYNC APPLINK component of the SYNC system provided by The Ford Motor Company of Dearborn, Mich., the CarPlay protocol provided by Apple Inc. of Cupertino, Calif., or the Android Auto protocol provided by Google, Inc. of Mountain View, Calif. The vehicle component interface application 174 may be once such application installed to the mobile device 152.

The vehicle component interface application 174 of the mobile device 152 may be configured to facilitate access to one or more vehicle 102 features made available for device configuration by the vehicle 102. In some cases, the available vehicle 102 features may be accessible by a single vehicle component interface application 174, in which case the vehicle component interface application 174 may be configured to be customizable or to maintain configurations supportive of the specific vehicle 102 brand/model and option packages. In an example, the vehicle component interface application 174 may be configured to receive, from the vehicle 102, a definition of the features that are available to be controlled, display a user interface descriptive of the available features, and provide user input from the user interface to the vehicle 102 to allow the user to control the indicated features. As exampled in detail below, an appropriate mobile device 152 to display the vehicle component interface application 174 may be identified, and a definition of the user interface to display may be provided to the identified vehicle component interface application 174 for display to the user.

Systems such as the system 100 and system 200 may interact with a mobile device 152 such as a mobile phone paired with the computing platform 104 and/or other setup operations. The mobile device may include an application configured to interface with the home network in which the application may send a request signal to initiate opening or closing of a garage door. Upon reception of the request signal to open or close the door the computing platform 104 may send a message to a rear lift gate module to open or close the lift gate.

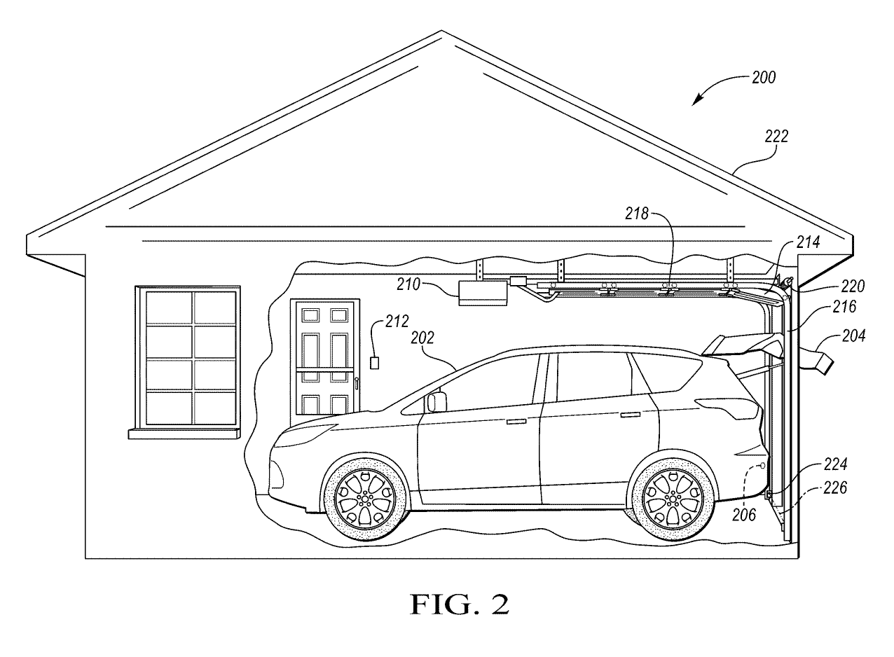

FIG. 2 is an exemplary cut away illustration of a communication system 200 between a house 222 having a garage and a vehicle 202 with an open liftgate 204 in the garage. The vehicle 202 may be coupled with the house 222 via a wireless connection, a wire connection, or inductive coupling. The vehicle includes rear sensors 206 such as an ultrasonic sensor. The house includes a garage door opener 210 and controller for the garage door opener 210. The garage door opener 210 is coupled with a wall switch 212 via a wire connection or via a wireless connection. The house includes a garage door 214 that travels along a rail 216 by rollers 218 attached to the garage door 214. Although the garage door opener exerts force on the garage door 214 to open and close, the majority of the force to move the door is from a tension spring 220 which provides a force generally equal the a force required to hold the door at a half open position. The garage door opener 210 is also coupled with a light sensor 224 that produces a light beam 226 across the bottom of the doorway of the garage door. In the event that an object breaks the beam 226 while the door 214 is being shut, the garage door opener 210 will be triggered to stop movement and enter an open door mode. If the door 214 is already closed, the sensor is typically not activated. If the door 214 is traveling in a direction to open the garage door 214, breaking the beam 226 will not change the operation of the door 214. As shown in this illustration, a liftgate 204 for a vehicle 202 in a garage may extend beyond a plane of the garage door 214 when closed. Depending upon the type of garage door such as a sectional door, the plane of the garage door 214 is typically between the rails 216. Thus, if the liftgate 204 is open when the garage door 214 is open, a request to shut the garage door 214 may cause the garage door 214 to contact the liftgate 204 and may cause damage to the liftgate 204, garage door 214 or both.

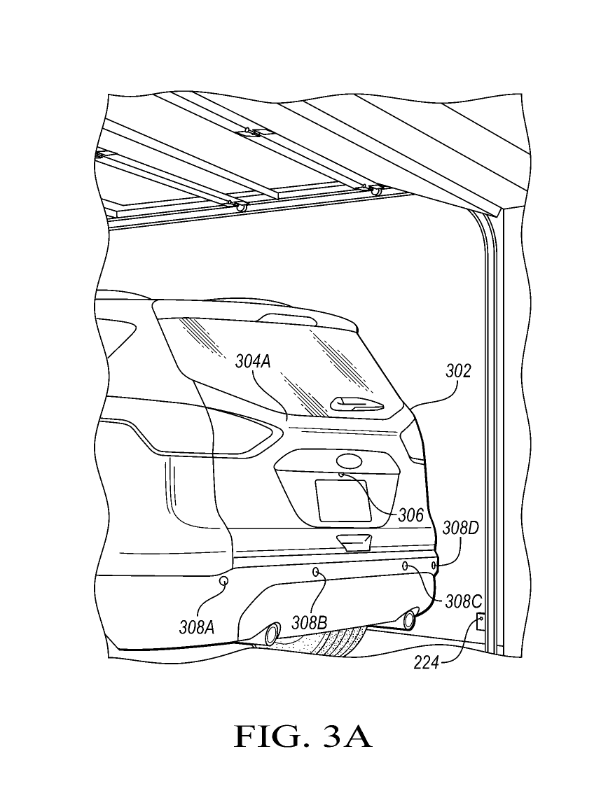

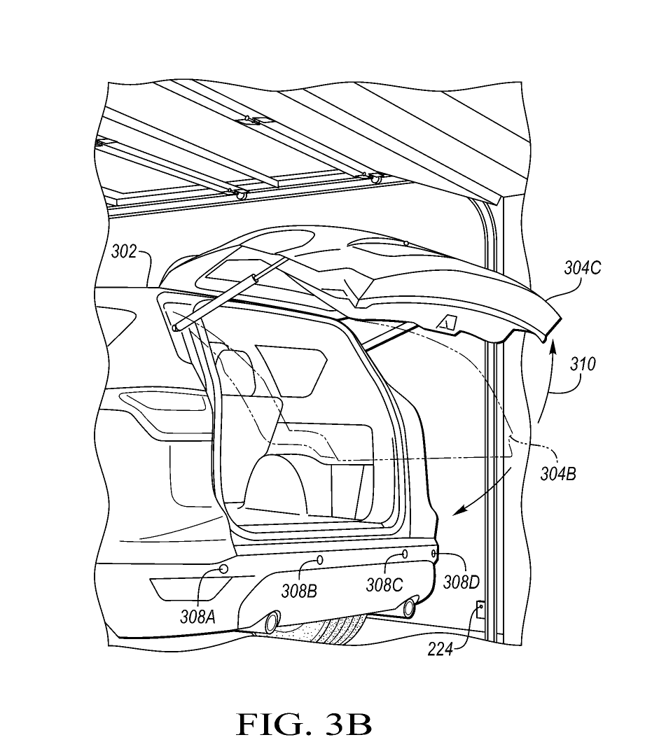

FIG. 3A is a rear view of a vehicle 302 having a liftgate 304 in a closed position 304A and rear sensors of the vehicle 302. The rear sensors include a backup camera 306 and parking/backup transducers 308. The rear sensors typically send signals indicative of a field of view and receive signal to control, active and operate the sensors. The backup camera typically is activated when the vehicle is in an operating mode such as when the ICE is running, the ignition is in an On or Run state, or power is coupled with the powertrain. Further, the backup camera is typically only activated when a transmission selection is a reverse direction. Here, the backup camera may be activated while the ICE of the vehicle is not running, the ignition is in an off state, or the transmission is in park. The backup camera may be coupled with a controller configured to process the signal indicative of a digital image in the field of view of the camera. Based on the processing the controller may be able to identify a closed garage door based on image recognition and identification of common garage door configurations. Also, the camera may be activated both when the rear enclosure is open or closed. The camera may also be activated as the rear enclosure is in motion. When the rear enclosure is in motion, the controller may scan the images to identify objects that may contact the door. The parking/backup transducers 308 usually include multiple transducers such as shown by 308A, 308B, 308C, and 308D. The transducers 308 are typically ultrasonic sensors, but may also be infrared, or other sensing technology. Multiple transducers 308 are used to provide data such that a more comprehensive detection may be performed. The parking/backup transducers 308 also referred to parking/backup sensors are typically activated when the vehicle is in an operating mode such as when the ICE is running, the ignition is in an On or Run state, or power is coupled with the powertrain. Also, the backup transducers 308 are typically only activated when a transmission selection is a reverse direction. Here, the backup transducers 308 may be activated when the ICE of the vehicle is not running, the ignition of the vehicle is in an off state, or the transmission is in park. The backup transducers 308 may be coupled with a controller configured to process signals from the transducers 308. FIG. 3B is a rear view of a vehicle having a liftgate 304 in an open position 304C illustrating a range of motion 310 of the liftgate.

The processes, methods, or algorithms disclosed herein may be deliverable to or implemented by a processing device, controller, or computer, which may include any existing programmable electronic control unit or dedicated electronic control unit. Similarly, the processes, methods, or algorithms may be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms may also be implemented in a software executable object. Alternatively, the processes, methods, or algorithms may be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A vehicle system comprising:
a controller configured to, in response to receiving a request to open a rear enclosure of a vehicle and data indicating that an object is behind the vehicle, transmit one or more signals to open a door of a garage and inhibit opening the enclosure, and in response to the data indicating an absence of objects behind the vehicle, open the enclosure.

2. The system of claim 1, wherein the controller is further configured to transmit the one or more signals only if location data for the vehicle indicates that the vehicle is in the garage.

3. The system of claim 1, wherein the controller is further configured to transmit the one or more signals in a 315 MHz, 390 MHz, or 433 MHz frequency band.

4. The system of claim 1, wherein the controller is further configured to transmit the one or more signals using Wi-Fi or Bluetooth.

5. The system of claim 1, wherein the controller is further configured to receive the request via Wi-Fi, Bluetooth, or a cellular network.

6. The system of claim 1, wherein the controller is further configured to derive the data from a backup camera signal or an ultrasonic sensor signal.

7. The system of claim 1, wherein the rear enclosure includes a lift gate, hatch, or door.

8. A vehicle comprising:
a rear access panel; and
a controller configured to, in response to receiving a request to close a door of a garage and a signal indicating that the rear access panel is open, close the rear access panel prior to transmitting a signal to close the door.

9. The vehicle of claim 8, wherein the controller is further configured to close the rear access panel prior to transmitting the signal only if location data for the vehicle indicates that the vehicle is inside the garage.

10. The vehicle of claim 8, wherein the controller is further configured to transmit the signal in a 315 MHz, 390 MHz, or 433 MHz frequency band.

11. The vehicle of claim 8, wherein the controller is further configured to transmit the signal using Wi-Fi or Bluetooth.

12. The vehicle of claim 8, wherein the signal is a backup camera signal or an ultrasonic sensor signal.

13. The vehicle of claim 8, wherein the rear access panel is a lift gate, hatch, or door.

14. The vehicle of claim 8 further comprising a switch, wherein the request is triggered by activation of the switch.

15. The vehicle of claim 8, wherein the controller is further configured to receive the request via Wi-Fi, Bluetooth, or a cellular network.

16. A method for activating a vehicle system comprising:
in response to receiving a request to remote start the vehicle and data indicating that the vehicle is in a garage and that there is an object behind the vehicle, transmitting by a controller a signal to open a door of the garage, and in response to the data indicating that the object is no longer behind the vehicle, honoring by the controller the request.

17. The method of claim 16, wherein the signal is a radio frequency (RF) signal.

18. The method of claim 16 further comprising deriving at least some of the data from a backup camera signal or an ultrasonic sensor signal.

19. The method of claim 16, wherein the data includes global positioning satellite data.

20. The method of claim 16, wherein the controller is further configured to receive the request via Wi-Fi, Bluetooth, or a cellular network.
